(19) United States
(12) Patent Application Publication
(10) Pub. No.: US 2012/0210353 A1
(43) Pub. Date: Aug. 16, 2012

(54) SECOND DISPLAY INTERACTION WITH SOCIAL NETWORKING FEED

(75) Inventors: Ling Jun Wong, Champaign, IL (US); Charles McCoy, Coronado, CA (US); True Xiong, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/232,598

(22) Filed: Sep. 14, 2011

Related U.S. Application Data
(60) Provisional application No. 61/441,887, filed on Feb. 11, 2011.

(51) Int. Cl. H04N 21/40

(52) U.S. Cl. 725/37

(57) ABSTRACT

Systems and methods are disclosed for publishing data to one or more social networking services in which data pertaining to a user's behavior in browsing, selecting, and playing an asset (e.g., media) from particular sources on a particular Internet television platform (IPTV), is tracked so that a feed representative of such behavior may be transmitted to the social networking services for publication as recommendations. In response to the feed, information pertaining to the user, the platform, the selected media, and the service providing the media may be presented on one or more pages provided by the social networking service. Viewers of the pages can add a recommended asset to an IPTV list for playback, add the user as an IPTV friend on their social networking page, and launch an application on a second display which may be used to control the platform.

### CROSS-REFERENCE TO RELATED APPLICATIONS

This application claims benefit of priority of U.S. Provisional Patent Application No. 61/441,887, filed Feb. 11, 2011, entitled “Second Display Interaction with Social Networking Feed”, owned by the assignee of the present invention and herein incorporated by reference in its entirety.

### BACKGROUND

Social networking websites have proliferated and become increasingly popular and present opportunities for IPTV (Internet Protocol Television) systems which currently tend to provide isolated, single user experiences. Although there are ways to add friends and share assets, this experience is limited to current IPTV owners. There is no existing way to share IPTV information and experiences via social networks so that knowledge of such products and such technology in the market may be broadened and IPTV user experiences enhanced.

### SUMMARY

Systems and methods are disclosed for creating and employing software to handle the browsing, selection, and playback of media, such as video, and other content and assets from external sources or services in web browsers that, in addition to or instead of playing the media in the web browser, use principles and protocols of a “second display” to instruct a content playback platform to play the selected media, for example on a platform that is optimized for media playback, such as an IPTV or other large television screen and/or on a home theater audio system. In some implementations, the software can be in the form of a browser plug-in or it can be in the form of a web application (“web app”) that the browser is configured to use to support the browsing, selection, and facilitation of playback of media on the optimized platform, the same having authenticated credentials for playback of such content. The software can execute locally or alternatively be implemented using a cloud computing paradigm in whole or part (i.e., in combination with local execution) in which some portion of application code executes remotely on the cloud. In such an implementation, the second display can download code and/or objects, stream code and/or objects from a remote server (in some instances in real time or near real time), call remotely executed procedures and the like, and/or partially download code for local execution while streaming other portions of code and executing remote procedures in combination therewith. Second display applications written in native code may also be employed. Data pertaining to the user's behavior in browsing, selecting, and playing media, from particular sources on a particular platform, is tracked (with the user's permission) so that a feed representative of such behavior may be transmitted to one or more social networking services for publication, for example, as a recommendation from the user. The publication may implemented, for example, in substantially real time (or near real time) on a per-user basis, or alternatively using a queue or bulk-based method in which publication to the social networking services is implemented for multiple users in non-real time. Tracked results may thus be published later in time to social networking services in cases, for example, where a local connection to the Internet is unavailable.

Responsively to the feed, information pertaining to the user, the asset (e.g., the selected media), the service providing the media, and the platform may be presented on one or more pages provided by the social networking service. A “share” control object such as a button or other user-selectable control may also be provided on the social networking page via the feed for sharing the feed to other users' social networking pages. A second display control object may also be supported on the social networking page via the feed that enables page viewers to directly launch their second display web app and/or the asset shown thereon. By embedding special tags in the feed that are compliant with protocols and methods that are supported by an API (application programming interface) exposed by a server in the social networking service, the data from the feed can be displayed on the pages with the same look and feel and user experience as native social networking content.

The IPTV information provided by the feed and published on the social networking page enables viewers to add a recommended IPTV asset to their IPTV list and then watch it instantly on their IPTV. In addition, by clicking on the user link on the social networking page, viewers can learn more about the IPTV user and add the user as a friend. When the viewer clicks on the asset link on the social networking page, the viewer's second display is launched and the present system exposes an asset ID (identification) so that the viewer can play the asset on his or her playback device (e.g., IPTV), or add it to various lists (e.g., favorites, IPTV list, queue for streaming video subscription service, etc.) that are supported in the IPTV domain. Alternatively, the second display can use the content playback device's authentication credential to search for the asset on the system and then retrieve the asset ID for playback on the device. If the asset is not able to be played back because the user's second display is not set to control an appropriate device, the viewer may change their control to an appropriate one and then access the recommended IPTV asset. In some cases, because of content restrictions, a viewer will be able to see the link and associated information but be unable to access the associated asset.

When the social networking page viewer clicks on the service link, the viewer can be directed to an information page served by an IPTV domain server that informs the viewer about IPTV service offerings. The information page can also include a link to the second display web app which directly launches the IPTV service from the viewer's second display. When the viewer clicks on the platform link, an information page from the IPTV domain can be made available to showcase features and benefits/advantages of various available IPTV platforms. From that platform information page, the viewer can link to the second display web app. In each of the above illustrative examples of social networking page viewer's interaction with pages that utilize feed information, if the viewer is not presently an IPTV/second display user, then a marketing page can be returned to the viewer to introduce him or her to IPTV features and service offerings.

To accomplish the above, software is employed that is installed to handle media playback. This software may have the ability to play the media in the browser, like traditional media handling software, in addition to the ability to control consumer electronics devices to enable the same to play the media. In other implementations, software may specify the network location of selected media to the content playback device. The content playback devices, e.g., consumer electronics devices, may be caused to be the source of the request for a content item from a service provider, e.g., by providing the content item URL or URI to the content playback device from the second display for a subsequent request to a service provider.

To control content playback device settings, a group of users may exploit individual “second displays” to control settings, view, browse, and navigate content or data service offerings, by service providers, e.g., Internet network services, on behalf of a content playback device, e.g., an IPTV, and then arrange for a selected content item or items to be played back on the content playback device.

The second displays serve as an additional control for the IPTV, but generally do not require additional investment by the user because the same make use of a device, e.g., a smartphone, laptop computer, tablet computer, a desktop, an Internet appliance, etc., which most users would already have in their possession. Such a second display is a perfect complement to an IPTV because of the second display's strength in supported languages and character font sets, data entry, processing power, and user experience in content management. The application running on the second display may be a web application (scripting or non-scripting), a native application, a Java application, or any other sort of application that may work with a content playback device. For example, the ASPI.NET framework with RPC can be employed to write the second display application. Where the web application running on the second display is written in HTML or HTML with Javascript, the same may be loaded by any device with a browser, and so the same is not limited to only a small set of compatible devices or expensive remote controls.

Communications with service providers may take place through a proxy server. The proxy server presents the authentication credentials of the content playback device to the service providers so that the second displays appear as authenticated content playback devices.

The second displays may include any device that can run an application that communicates with a content playback device, including, but not limited to, personal computers, laptop computers, notebook computers, netbook computers, handheld computers, personal digital assistants, mobile phones, smartphones, tablet computers, hand-held gaming devices, gaming consoles, and also on devices specifically designed for these purposes, in which case the special device would include at least a processor and sufficient resources and networking capability to run the web app.

The content playback device can take many forms, and multiple content playback devices can be coupled to and selected within a given local network. Exemplary content playback devices may include IPTVs, DTVs, digital audio systems, or more traditional video and audio systems that have been appropriately configured for connectivity. In video systems, the content playback device includes a processor controlling a video display to render content thereon.

In a general method, a user employing a second display has a user account with a source or clearinghouse of services. Here, the source or clearinghouse is represented as a user account on a management server, but it should be understood that the user account may be with a service provider directly. In any event, this account has information stored thereon related to what content playback devices are associated with the account. When a user logs on, they may see this list of content playback devices and may choose a particular content playback device. If there is only one content playback device on the network, or if the user is browsing in a way that the content playback device identity is not needed, then this step may be omitted.

Once a content playback device has been chosen, a list of services may be displayed (if more than one is available). The list of services may be customized to those that have content playable on the chosen content playback device, or all available content may be displayed, in which case, in certain implementations, a notation may be displayed adjacent to the content item as to whether it is playable on the selected device. Where no content playback device has been selected, all available content may be displayed. If no content playback device has been selected, but the user account includes stored information about which content playback devices are available, then all content may be displayed, a subset of all content may be displayed based on the known content playback devices associated with the account, or notations may be presented about which content playback devices can play which content, or a combination of these. In some cases, a content service provider may require a content playback device to be chosen. In other cases, no content playback device need be chosen and the user may simply choose and queue content for later playback by a content playback device to be determined at a later time.

Assuming multiple services are available, the user then selects a service to browse. The service presents a list of available content items as noted above. The presentation may be in any number of forms, including by category, or in any other form of organization. The proxy server presents an authentication credential of the content playback device to the content server. In some cases, service provider credentials for accessing the various services may be stored in the account, and presented by the proxy server or management server to the content server when needed.

Individual services may employ their own DRM schemes which the current system may then incorporate. For example, if a video content service provider only allows a certain predetermined number of devices on which their content may be played back, then this rule will be enforced or duplicated within the current system and method. Moreover, changes to such service provider parameters may be periodically polled for by the proxy server and/or management server, or the same may be polled for at the next login of the service. In other words, upon login, the system and method may poll for and receive a token associated with the given service provider, the token providing information to the system about the user account with the content service provider.

The system and method may include a management server which, along with the content playback device, communicates with at least one content server such that the content server provides content items for presentation or access of the content item at the content playback device. The system and method may further include a proxy server communicating with the management server and the second displays. In some cases, the proxy server may be merged with the management server, or in other cases a separate proxy server may be provided for each content server or service provider.

A proxy server is further provided which includes at least one processor and at least one network interface communicating with the processor to establish communication between the processor and a wide area network. At least one computer-readable storage medium is accessible to the processor and bears logic causing the processor to receive login information from a second display. Responsive to a determination that the login information is correct, the server sends to the second display a local IP address of the content playback device associated with the login information. The proxy server receives from the second display information about the content playback device requesting a list of services available to the content playback device from at least one content server of a service provider and sends a request for the list of services to a management server. The proxy server receives from the management server the list and sends it to the second display for presentation of information on a video display thereof. The proxy server receives from the second display a request for a content item and, responsive to the request of the content item, requests a service login of the content server. The proxy server receives back from the content server a list of items, assets, categories or services and sends the list to the second display. In this way, the list can be presented on a video display of the second display so that a user can navigate to enter a selection to command the content playback device to play the selection.

In one aspect, the invention is directed towards a method for facilitating interaction between a second display and a social networking feed, including: receiving a social networking feed that includes tracked data representative of browsing, selection, or playback of an asset by an IPTV user; generating one or more social networking pages for consumption by a viewer of the pages, the generating using the received feed, the social networking pages including at least one of an IPTV user link, asset link, service link, platform link, share link, or second display link; and implementing control for the interaction at the second display responsively to selection of a link by the viewer from the one or more social networking pages.

Implementations of the invention may include one or more of the following. The implementing may include instantiating an application on the second display, the application being one of a web app, native application, Java application, or application written using ASPI.NET framework. The implementing may include causing the asset to play back in a content playback device associated with the viewer. The causing may include causing the content playback device to request the asset from a content server. The second display may be authenticated using an authentication credential associated with the content playback device. The generating may be performed by a social networking service provider. The feed may include tags compliant with an API exposed by a server operated on behalf of the social networking service provider. Upon selection of the IPTV user link by the viewer, a social networking page providing information about the IPTV user may be presented for viewing by the viewer, the social networking page further including a link for the viewer to invoke the second display or an option for the viewer to add the IPTV user as a social networking friend. Upon selection of the asset link by the viewer, viewer-selectable options may be presented on the second display, the options including at least one of causing the asset to playback on a content playback device, or putting the asset on a list, the list comprising a favorites list or a queue for a video-stream subscription service. Upon selection of the service link by the viewer, an IPTV domain page providing information about an IPTV service may be presented for viewing by the viewer, the IPTV domain page further including a link for the viewer to invoke the second display. Upon selection of the platform link by the viewer, an IPTV domain page providing information about an IPTV platform may be presented for viewing by the viewer, the IPTV domain page further including a link for the viewer to invoke the second display. Upon selection of the share link by the viewer, the feed may be shared with a social networking user specified by the viewer. A connection between the content playback platform and second display may be wireless, and an exemplary wireless transmission scheme may include a scheme selected from the group consisting of: WiFi, 802.11, 802.15, or 802.16. The received feed may be personalized on a per-viewer basis and may be adapted for publication in substantially real time or the feed may be configured to be representative of a plurality of viewers and may be further adapted for publication in bulk in substantially non-real time.

In another aspect, the invention is directed towards a non-transitory computer-readable medium, comprising instructions for causing a computing device to implement the above method.

In another aspect, the invention is directed towards a second display, including: a display module, the display module providing a user interface and configured to display a content item or to receive a content item URL/URI; an asset search and retrieval module adapted for searching and retrieving an asset recommended from an IPTV viewer and published in a feed to a social networking service; and a network communications module, the network communications module for coupling the second display to a local network or to a content playback device and for causing the recommended asset to playback on the content playback device.

Implementations of the invention may include one or more of the following. The second display may further include a browsing module for browsing content items. The browsing module may be implemented in HTML, Javascript, or a native code using at least one of local execution, cloud-computing paradigm, or combination thereof. The browsing module may be a web-browsing module. The coupling may be via a wireless communication scheme.

In another aspect, the invention is directed towards a method for using a feed from an IPTV domain at a social networking service, including: receiving a feed populated with one or more data objects at an API exposed by the social networking service, the data object representing at least one of an asset, IPTV service, IPTV platform, or IPTV user, the asset being provided from the IPTV service to which the IPTV domain is coupled over a network; generating one or more social networking pages incorporating the data objects from the feed as native social networking content; enabling a viewer of the pages to manipulate the data objects; and invoking an action in response to the manipulation.

Implementations of the invention may include one or more of the following. The invoke action may include provision of additional information from the feed. The additional information may be one of information about the IPTV service, IPTV platform, or IPTV user. The invoke action may include passing control from the social networking pages to a page in the IPTV domain or to a second display associated with the viewer. The control passed to the second display may enable the viewer to cause the asset to play back on a content playback device. The asset may be a recommended asset generated by tracking browsing, selection, and playback behaviors of the IPTV user.

Advantages of certain embodiments of the invention may include one or more of the following. Ways are provided to publish data about users in the form of a feed to social networking services from the IPTV domain with which social networking page viewers can interact in various ways. Feeds can be personalized to different users of the IPTV system and/or tailored to viewers of the social networking service. Extending the IPTV domain into popular social networking services can broaden the appeal of IPTV and significantly enhance the IPTV user experience.

Other advantages will be apparent from the description that follows, including the figures and claims.

### BRIEF DESCRIPTION OF THE DRAWINGS

Like reference numerals denote like elements throughout.

FIG. 1 is a block diagram of an exemplary system in accordance with an aspect of the present principles.

FIG. 2 is a block diagram of another exemplary system in accordance with an aspect of the present principles.

FIG. 3 is a sequence diagram illustrating a system and method according to an aspect of the present principles.

FIG. 4 is sequence diagram illustrating a system and method according to an aspect of the present principles.

FIG. 5 shows data objects that may be implemented in one or more pages provided by a social networking service.

FIG. 6 is a flowchart illustrating an exemplary method in accordance with an aspect of the present principles.

FIG. 7 is a flowchart illustrating an exemplary method in accordance with an aspect of the present principles.

FIG. 8 is a block diagram of an exemplary second display system in accordance with an aspect of the present principles.

FIG. 9 is a block diagram of another exemplary second display system in accordance with an aspect of the present principles.

FIG. 10 illustrates an exemplary computing device, for example, that of the disclosed second display, proxy server, management server, content server, web server, computing device, or social network server.

### DETAILED DESCRIPTION

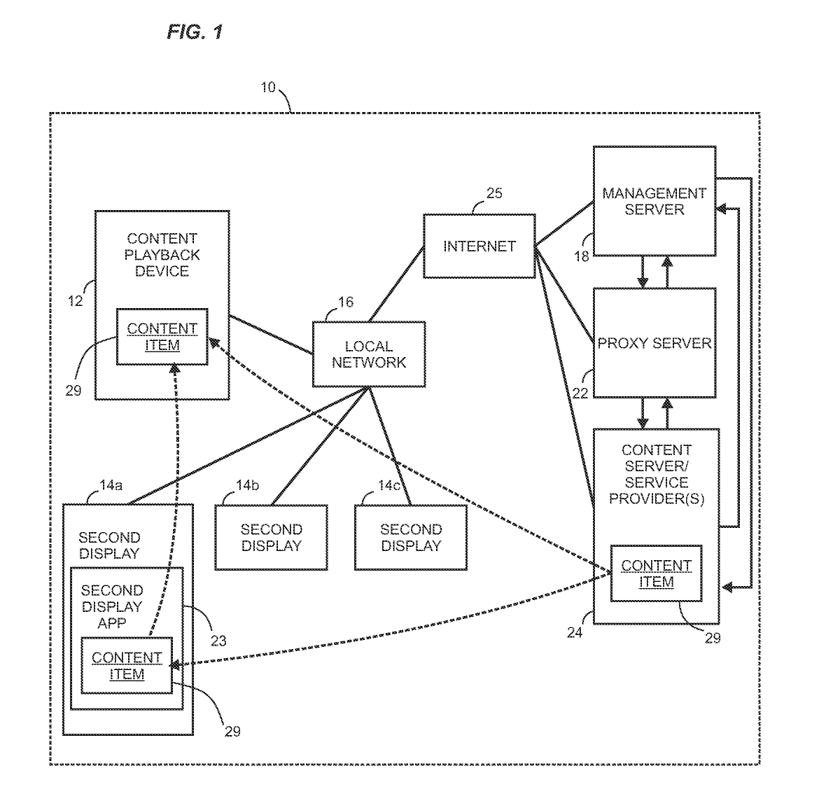

Referring initially to FIG. 1, a system 10 is shown including a content playback device 12 coupled to a local network 16, which may be wired, wireless, or a combination of both. Also coupled to the local network 16 are one or more second displays 14a-14c, an exemplary one of which is termed herein second display 14i. A number of servers may be accessed by the content playback device 12 and the second display 14i through the local network 16 and the Internet 25, including a management server 18, a proxy server 22, and one or more content servers 24 corresponding to service providers. It is noted that the Internet 25 is optionally utilized as there are usage scenarios in which the system 10 can be implemented so that the various features and functionalities provided by the management server 18, proxy server 22, and content servers 24 can be instantiated locally in either the local network, the second display 14i, or playback device 12 or in various sub-combinations therein. For example, various types of closed-circuit network or in-home networks can be utilized in whole or part to implement portions or all of the system 10.

A content item 29 may be stored on a content server 24 and the same may be viewed by a second display 14a. In particular, the content item 29 may be viewed in a second display application 23 that typically executes HTML and/or Javascript code (e.g., a web app) that runs in a browser of the second display. While a web application is discussed here, one of ordinary skill in the art will recognize that non-web applications are also encompassed by the current principles, including those employing native code. The user of the second display 14a can then direct that the content item be displayed in the content playback device 12. The code utilized to instantiate the second display application 23 can be executed locally or by implementing a partial or full cloud-computing paradigm in which various combinations of locally executed code, downloaded code and objects, and/or streaming code and objects (including for example, that which executes in real time or near real time), are supported as may be needed to facilitate the functionalities of the second display as described herein.

The content playback device 12 may obtain the content item 29 for playback in a number of ways. Generally, the content playback device 12 receives the content item directly from the service provider (or an intermediary source). For this type of transmission, the second display 14a may send a signal to the service provider through the local network 16 and/or Internet 25 to the service provider. For example, where the second display application is a web application, the same may include Javascript in HTML that directly passes the desired URL/URI onto the content playback device. If necessary, the proxy server 22 may be employed, although in many cases content items 29 suitable for viewing in the second display application 23 may be obtained directly from the service provider. Many of these include DRM-free content or other freely-distributable content. In any case, other details about methods by which a second display may request that a content item appear on a content playback device are described below. In some cases, the second display 14a may directly transmit the content item 29 to the content playback device 12. This direct transmission may be by way of a direct wired or wireless connection, such as via USB, WiFi, or the like. For such direct transmissions, the second display 14a may act to buffer the media stream constituting the content item 29 in some implementations.

The content playback device 12 may be, e.g., an IPTV, a digital TV, a digital sound system, a digital entertainment system, a digital video recorder, a video disc player, a combination of these, or any number of other electronic devices addressable by a user on the local network 16. For the sake of simplicity, in this specification, the content playback device 12 will occasionally be exemplified by an IPTV, in which case it will generally include a processor that controls a visual display and an audio renderer such as a sound processor and one or more speakers. The processor may access one or more computer-readable storage media such as but not limited to RAM storage, e.g., a chip implementing DRAM, flash memory, or disk-based storage. Software code implementing present logic executable by the content playback device 12 may also be stored on one of the memories shown to undertake present principles. The processor can receive user input signals from various input devices including a remote control device, a point-and-click device such as a mouse, a keypad, etc. A TV tuner may be provided in some implementations, particularly when the content playback device 12 is embodied by an IPTV, to receive TV signals from a source such as a set-top box, satellite receiver, cable head end, terrestrial TV signal antenna, etc. Signals from the tuner are then sent to the processor for presentation on the display and sound system. A network interface such as a wired or wireless modem communicates with the processor to provide connectivity to the Internet through the local network 16. It will be understood that communications between the content playback device 12 and the Internet 25, or between the second display 14i and the Internet, may also take place through means besides the local network 16. For example, the second display 14i may communicate with the content playback device 12 through a separate mobile network.

The one or more second displays 14a-14c each bear a processor and components necessary to operate a second display application, e.g., a web application. Other types of applications may also be employed, so long as the same are capable of arranging for a content item to be played back on a content playback device. In particular, the processor in the second display may access one or more computer-readable storage media such as but not limited to RAM-based storage, e.g., a chip implementing DRAM, flash memory, or disk-based storage. Software code implementing present logic executable by the second display may also be stored on one of the memories shown to undertake present principles. Further, the second display 14i can receive user input signals from various input devices including a point-and-click device such as a mouse, a keypad, a touchscreen, a remote control, etc. A network interface such as a wired or wireless modem communicates with the processor to provide connectivity to wide area networks such as the Internet as noted above.

The servers 18, 22, and 24 have respective processors accessing respective non-transitory computer-readable storage media which may be, without limitation, disk-based and/or solid state storage. The servers communicate with a wide area network such as the Internet via respective network interfaces. The proxy server 22 may in some cases be combined with the management server 18, although in many cases it may be preferable to separate the servers to better accommodate server load. The servers may mutually communicate via the Internet 25. In some implementations, the servers may be located on the same local network 16, in which case they may communicate with each other through the local network without accessing the Internet 25. For example, in one exemplary implementation, the management server 18 and the proxy server 22 may be disposed in the same data center, so communication between the two may stay within the data center.

While an exemplary method of the system is described below, certain method steps especially pertinent to certain arrangements of the second display will be described here.

Responsive to the second display 14i sending a request to the proxy server 22 for an executable utility, the proxy server 22 returns the utility to each second display 14i. Running the utility causes the instantiation of an application. As noted, the implementation discussed here includes a web app, but it will be understood that other types of applications may also be employed as described above. The second display 14i, executing the web app, prompts a user to input to each second display 14i login information. The login information may be common or may differ between second displays. The proxy server 22, responsive to reception of correct login information from the content playback device 12, returns the local IP address of the content playback device 12 to the second display 14i, because the same has previously been registered to a user account in which such information is maintained. The proxy server 22 may also return a list of content playback devices on the local network, responsive to which the second display 14i may select one for content playback. In turn, each second display 14i uses the local content playback device address to access the content playback device 12 directly to request information about the content playback device 12, which information is returned from the content playback device 12 to the second display 14i such that the local address of the content playback device 12 need not be globally addressable. Each second display 14i may also select content for playback on different content playback devices. The second display 14i sends the information about the content playback device 12 to the proxy server 22, requesting a list of services available to the content playback device 12 from one or more service providers. The services may be dependent on the device characteristics of the content playback device 12 chosen. For example, if the chosen content playback device 12 is an IPTV, video services may be returned. If the chosen content playback device 12 is an audio system, audio services may be returned.

The proxy server 22 relays the request for a list of services to the management server 18, which returns the list to the proxy server 22, with the proxy server 22 in turn sending the list to the second display 14i for presentation of information on the second display 14i. Responsive to a user selection of an item on the list, the second display 14i sends a request for a software asset corresponding to the selected content item to the proxy server 22. The proxy server 22 requests a service login of the content server 24 providing the content, and the content server 24 provides to the proxy server 22 a list of content items, categories, or services (collectively termed as an “asset” or “assets”), and the proxy server 22 relays the list to the second display 14i, which is presented on the second display 14i so that the user can navigate to enter a selection. Responsive to the selection, the second display 14i sends a command to the content playback device 12 to access and play back the selection.

The command to play the local content item may be in a number of forms. The second display 14i may communicate to the proxy server 22 the request on behalf of the content playback device 12, and this request may be via the local network or via other means. Alternatively, the second display 14i may transmit a request to the content playback device 12 that it itself formulate the request, and this transmission may be by way of the local network, the Internet generally, or via other means such as other wired or wireless transmission schemes, including via USB, infrared, Bluetooth®, or any other schemes. If the second display 14i is configured to address the content playback device 12 at a nonlocal level, e.g., at the server level, then the second display 14i may be physically located virtually anywhere and still be able to queue content or to command the content playback device 12 to play content. In this case, however, server load would increase over the case where the second display and content playback device communicated directly or over a local network.

Certain method steps of an arrangement of the content playback device are described here. Using a network interface, the content playback device 12 can communicate with a management server 18 on the Internet and with one or more content servers 24, also on the Internet and communicating with the management server 18. The management server 18 receives and stores a local IP address of the content playback device 12. The content playback device 12 communicates with the management server 18 to arrange for content items from the content server 24, operated by a service provider, to be played back on the content playback device 12. In more detail, the content playback device 12 sends login information to the management server 18 which returns to the content playback device 12 a user token that must subsequently be presented by the content playback device 12 to the content server 24 to obtain content from the content server 24.

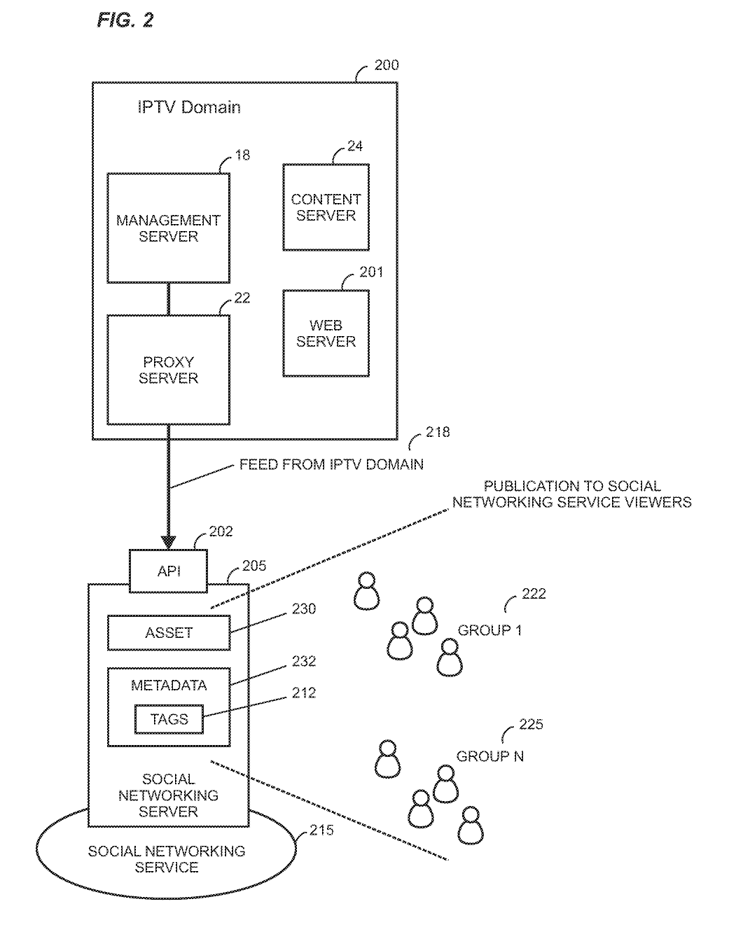

FIG. 2 shows an additional aspect of the present arrangement in which one or more servers 205 associated with a social networking service 215 are further operatively coupled to the servers 18, 22, and 24 in the IPTV domain 200. Also disposed in the IPTV domain 200 is an exemplary web server 201 for serving web pages associated with the IPTV domain 200 (as described in more detail below). The servers 18 and 22 are arranged to provide a feed 218 to the server 205 so that information from the IPTV domain 200 may be published to viewers of the social networking service 215. The viewers may include individuals or various groups (representatively indicated by viewer groups 1 to N in FIG. 2 as indicated by reference numerals 222 and 225). In the exemplary arrangement shown in FIG. 2, the server 205 can typically expose an API (Application Programming Interface) 202 so that information from the feed 218, including an asset 230 and associated metadata 232, can be formatted and presented in a way that enables the feed 218 to be displayed in a similar manner to native content on the social networking service 215. Typically, the metadata 232 can incorporate the use of specific tags 212 that are consistent with protocols exposed by the API 202. In this way, assets from the IPTV domain 200 can be conveniently and advantageously shared into the increasingly popular social media networks that can be implemented across a wide array of platforms and which can facilitate various communication and content-sharing services to the groups 222 and 225. For example, as described in more detail below, a user of systems according to the present principles may post IPTV assets and recommendations as feedback to a social networking service via the second display (e.g., the second display 14i in FIG. 1).

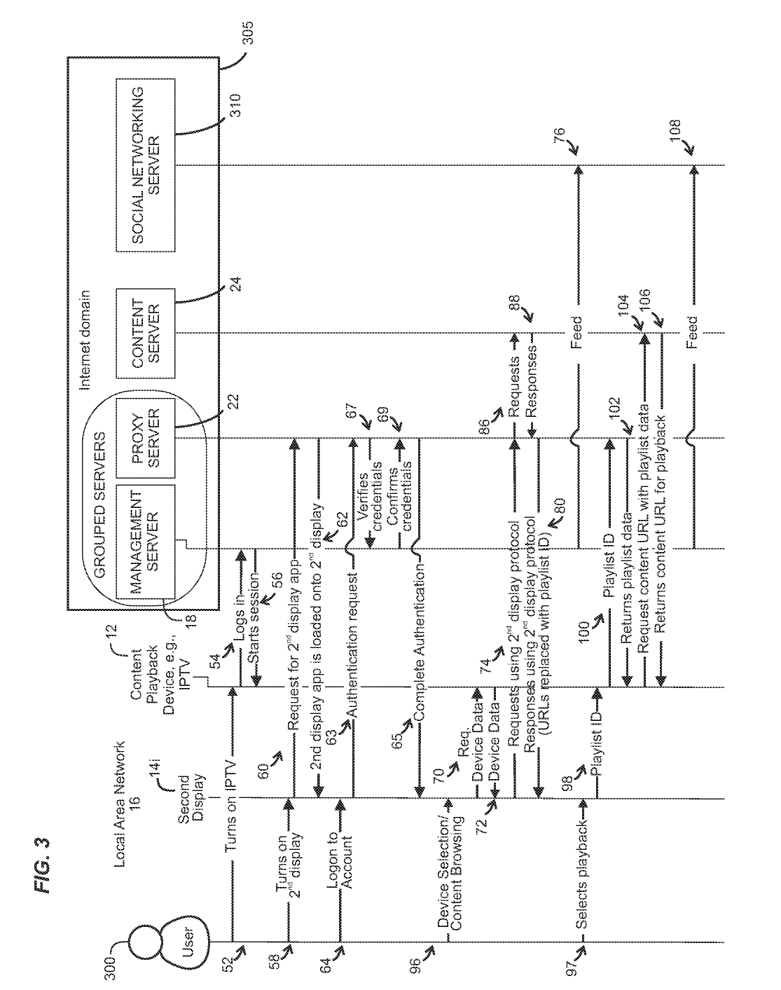

FIG. 3 is a sequence diagram illustrating an exemplary implementation of the system and method for enabling a user 300 to employ a second display to browse content playback devices, service providers, and content items and select the same for playback by a content playback device and post certain assets and information to the social networking service 215 via the feed 218. The user 300 interacts locally with the second display 14i and content playback device 12 over a local area network 16. The network 16 is operatively coupled to various servers in the Internet domain 305. FIG. 3 assumes that the user 300 has already created an account with a management server and has affiliated one or more content playback devices with that account.

At state 52, the user 300 turns on the content playback device 12. At state 54 the content playback device sends login information including, for example username and password, to the management server 18, which at state 56 returns to the content playback device 12 a user token that may subsequently be presented by the content playback device to a content server 24 to obtain content from that server. The management server 18, in addition, stores the local IP address of the content playback device 12.

At state 58, the user 300 turns on the second display 14i and, for example, instantiates a web browser session in which control may be exercised over the content playback device. A utility is executed on the second display 14i, at state 60, which sends a request to the proxy server 22, which returns in state 62 the second display application such as a web app implemented using, for example, HTML with JavaScript that executes on a helper application, plug-in, or utility of the browser, for the second display to execute for browsing content items. The web application may make, for example, asynchronous JavaScript and XML calls to the proxy server 22 and to the content playback device 12 to obtain information to control the content playback device 12.

With more specificity, at state 64, using the JavaScript received from the proxy server 22, the second display 14i prompts the user 300 to input to the second display 14i the account login information, including for example, the same username and password that the content playback device provided to the management server 18 in state 54 during device registration. Of course, the account login information may differ as well. It will be appreciated that the servers 18, 22, and 24 communicate necessary account information between them as needed to realize the principles described here.

The proxy server 22 responds to a correct user name and password from the second display 14i in an authentication request state 63. The proxy server 22 verifies the user name and password with the management server 18 (states 67 and 69), creates and transmits a session token to the second display, obtains information about content playback devices affiliated with the user account, and completes the authentication in state 65. The proxy server 22 may return to each second display the information about all content playback devices 12 that are affiliated with the user account associated with the user name and password, including their local IP addresses which were stored by the management server 18 after login at 54 (and subsequently provided to the proxy server 22). In more detail, the proxy server 22 sends a token to the second display 14i, the token associated with a content playback device, and this token gets communicated in future transactions between the second display and the proxy server, so that the proxy server 22 knows what content playback device the content item is intended for. Each user with each second display may then choose a content playback device and browse the services and content options available through the services in state 96 and subsequent steps.

The second display 14i, using the local IP address returned as noted above, accesses the content playback device directly, in the sense of communicating through the local network. To select a particular content playback device, the second display 14i requests information about the content playback device 12 at state 70, including language information, digital rights management (DRM) information, etc., as desired, which information is returned from the content playback device to the second display 14i at state 72. Since the second display 14i knows the IP address of the content playback device 12 and consequently communicates directly with the content playback device 12, the second display 14i communicates using a local web address of the content playback device 12 that need not be globally addressable, and may so communicate as long as the second display 14i and content playback device 12 are on the same local network.

Each second display 14i may send the client information received at state 72 to the proxy server 22, requesting a list of services available to the content playback device 12, or that the content playback device 12 is entitled to, from one or more of the content servers 24. The proxy server 22 relays the request to the management server 18, which returns the requested service list to the proxy server 22. The proxy server 22 in turn sends the services list to the second display for presentation of available services on, for example, a display of the second display. Each user browses the services and their content on the second display just as though it were the actual content playback device.

The user's browsing behavior may optionally be published to the social networking service 215 (FIG. 2) at state 76. In many cases, this optional feature can be implemented so that the user 300 can opt in to (or in some implementations, opt out of) having the system 10 (FIG. 1) automatically publish the user's browsing behavior or a subset thereof. The management server 18 (alone or in combination with the proxy server 22) can monitor the user's logins to various services exposed by the content server 24 and provide that information as an asset and/or related information (e.g., metadata) to a social networking server 310. For example, the user 300 might log in to a movie service to browse the latest movies available on-demand. In such case, for example, the feed 218 (FIG. 2) could consist of a service login history, the movies' titles or genres browsed by the user 300, and related metadata. The social networking service could then, in turn, make information from the feed 218 available to the certain ones of the viewers 222 and 225 (FIG. 2). For example, friends of a user named John on the social networking service 215 might be informed with an alert or post stating that “John checked out Service Y for the latest action movies to watch on his IPTV at 4:15 pm on Tuesday!” In this example, it may be possible that a content provider, such as a movie studio, supply the information and other content-specific data that can be incorporated into the feed 218.

Continuing with the description of the sequence diagram in FIG. 3, the user 300 can input, using for example, a second display input device, a selection of a service on the list that was returned to the second display. In response, the second display, at state 74, sends a request for the corresponding service to the proxy server 22 along with the service token that the second display may have received from the content server 24 via the management server 18.

Responsive to the request, the proxy server 22 requests a service login at state 86 of the content server 24 providing the selected service. At state 88, the content server 24 provides to the proxy server 22 a list of content items, assets, categories or services, as the case may be, for the particular content server 24. If desired, the proxy server 22 may also request of the content server 24 a list of options, and the list may be returned in, for example, extended markup language (XML) format to the proxy server 22 which relays the content items, assets, categories, services, etc. available for selection to the second display at state 80.

The content available for selection is presented on the second display so that the user 300 can navigate the display to enter a selection in state 97. Responsive to the selection, the second display, at state 98, sends a command to the content playback device 12 to play the selection, and in particular sends a playlist ID or reference identifier indicating the selection. At state 100, the content playback device 12, using its authentication credentials, sends the playlist ID or reference identifier to the proxy server 22, which returns the required playlist data in state 102. The content playback device 12 can then request the content URL/URI with the playlist data in state 104, which may be responded to with a return of the content URL for playback of the content item on the content playback device 12 in state 106.

As states 97 through 106 are implemented and the system 10 (FIG. 1) is preparing an asset for playback on the content playback device 12, the management server 18 (alone or in combination with the proxy server 22) can prepare and send the feed 218 (FIG. 2) to the social networking server 310 so that the relevant asset and related information (e.g., metadata) may be published by the social networking service 215 at state 108.

It is noted that states 76 and 108 in FIG. 3 can be configured to be automatically implemented (typically when selected by the user to be performed automatically), or may alternatively be implemented in response to an affirmative and explicit action by the user. For example, the user may desire not to have his or her asset browsing and selection activities automatically published to the social networking service and instead choose to publish the asset on a case by case basis where an explicit affirmation from the user is needed before an asset will be shared. In both implementations, the appropriate user interface can be provided on the second display to enable automated publishing preferences and parental controls to be set and/or explicit sharing actions to be performed. For example, in an IPTV household, some younger users may not be allowed to enable automatic publishing and might further be restricted in affirmative sharing as to the types of information that can be shared to the social networking service, the times when information may be shared, and the like. In addition to supporting different preferences and/or restrictions on a per-user basis, the present arrangement may also be configured to enable the feed to be customized on a per-user basis and/or per-social networking viewer basis so that different feeds can go to different viewers depending on the particular IPTV user, user-selected preferences, explicit or affirmative user actions, or combinations thereof.

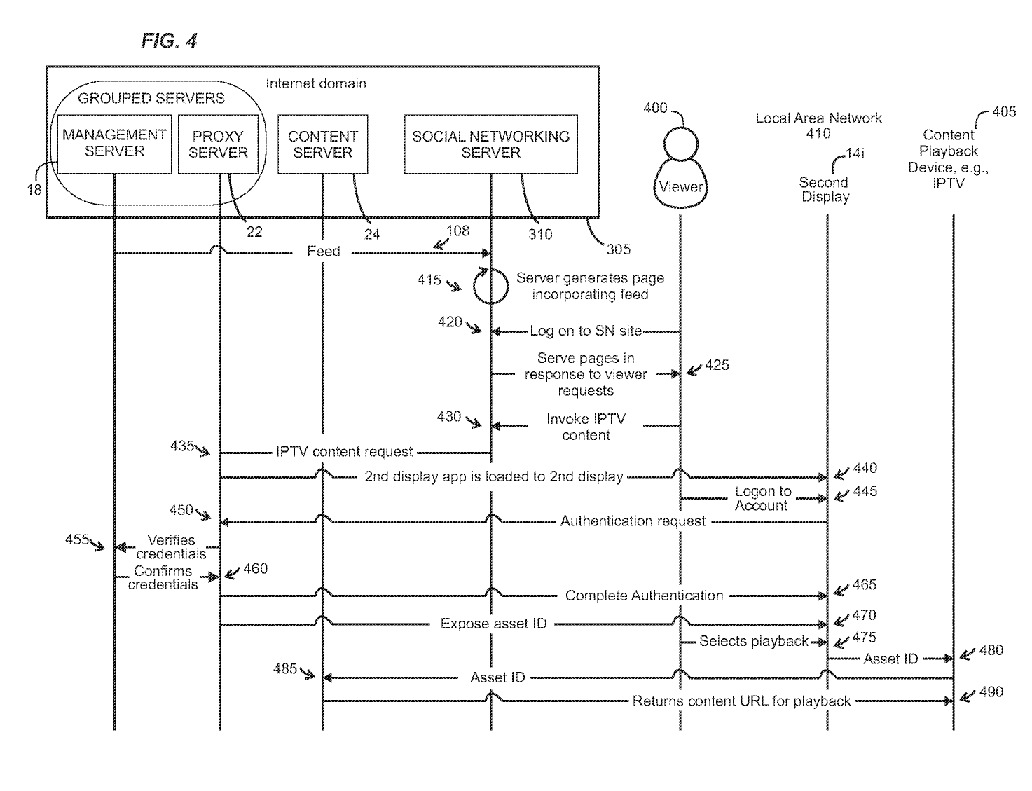

FIG. 4 is a sequence diagram illustrating an exemplary implementation of the system and method for enabling a viewer 400 of pages published by the social networking server 310 (shown in FIG. 3 and described in the accompanying text) to interact with various objects presented in the published pages. The page viewer 400 interacts locally with another instance of a second display 14i, content playback device 405 over a local area network 410. The network 410 is operatively coupled to the servers in the Internet domain 305, as shown. The feed is received by the social networking server 310 at state 108 (as also shown in FIG. 3). At state 415, the social networking server 310 will generate one or more pages which incorporate objects generated using the received feed. The viewer 400 will logon to the social networking site at state 420, and be served pages from the server 310 in response to viewer requests, at state 425. When the viewer invokes IPTV content at state 430, for example by clicking on the asset link on a social networking page, then the server 310 will transfer control for the user experience to the proxy server 22 via an IPTV content request, at state 435.

The second display application, for example a web app, is loaded to the second display at state 440 and the social networking page viewer 400 can log on to his or her account with the management server 18 using the second display 14i, at state 445. An authentication request is sent to the proxy server 22 at state 450. At state 455 and 460 respectively, the proxy server 22 will verify credentials with the management server 18, and the server will confirm the credentials as appropriate. Upon completion of authentication at state 465, the proxy server 22 can expose the ID of the recommended asset to the second display 14i at state 470. When the page viewer 400 selects playback of the asset at state 475, the asset ID is transferred to the content playback device 405, at state 480. At state 485, the content playback device 405 can then utilize the asset ID to retrieve the recommended asset. The content server returns the content URL/URI responsively to the asset ID, at state 490.

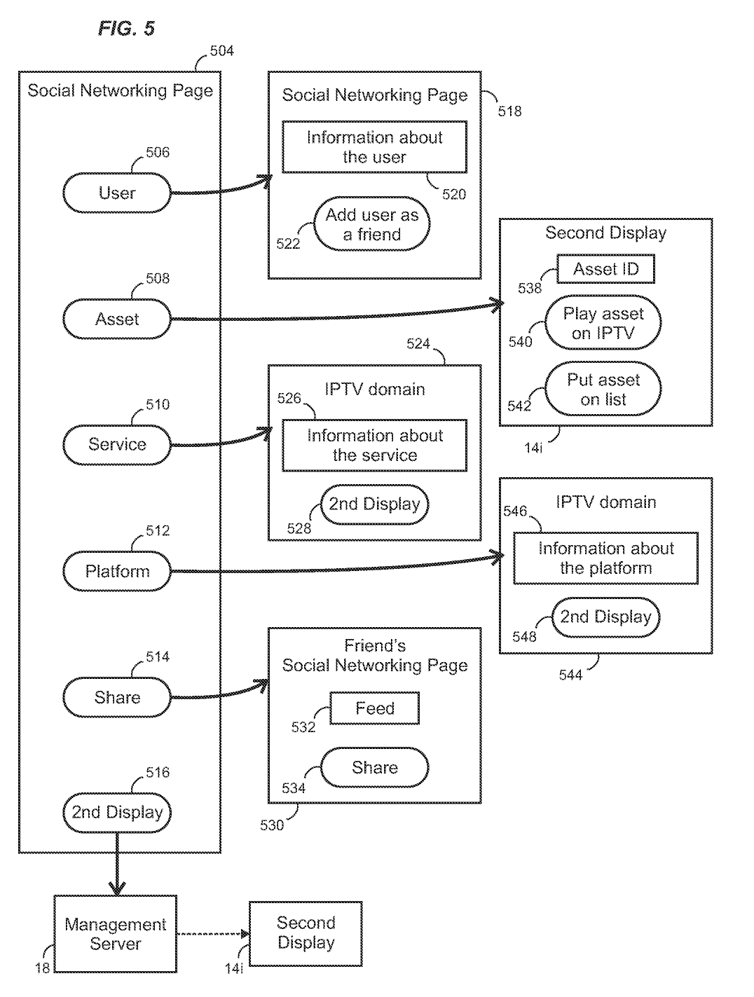

As shown in FIG. 5, the feed data may be configured using the special tags 212 (FIG. 2) that are recognized by the API exposed by the social networking service so that, for example, information about the user, asset, platform, service, and IPTV platform can be published on one or more pages 504, 518, and 530 of the social networking site in a similar manner as native content. Exemplary data objects included in the feed representing published information are respectively indicated by reference numerals 506, 508, 510, 512, 514, 516, 520, and 532 in FIG. 5.

In some implementations, the pages 504, 518, and 530 can also include native social networking content and/or features and functionalities. For example, support may be provided for the social network service viewers to post comments, links, content items, assets, and the like to the pages 504, 518, and 530 to supplement the data objects such as links included in the feed 218 from the IPTV domain 200. In other implementations, the supplemental data can be provided as feedback to the user whose browsing or selection behavior prompted the feed. For example, comments from social networking viewers (who could be friends of the user, for example) regarding the asset may be provided to the user's second display as the asset plays back on the user's IPTV. The management server may be configured to expose a form on the second display which may be used by the user to post comments on the asset to the social networking service 215.

The published information may typically be implemented using HTML code and links so that the social networking network viewer (e.g., viewers 222 and 225 in FIG. 2) can click on an object on a page such as a link, for example, to invoke additional commands or get additional information. Information 520 about the user is shared on a social networking page 518 when the social networking page viewer 400 (FIG. 4) clicks on the user link 506. Such information is typically information that the user has chosen to make public such as user name, profile, and the like. The information 520 can include a link to the user's social networking page or a link to an external webpage (these links not shown). In some implementations of the present arrangement, advertising can be included in the feed which is directed to users/viewers based on such profile. The viewer can add the IPTV user as a social networking friend by clicking on link 522 on the social networking page 518.

When the social networking page viewer 400 clicks on the asset link 508, the second display 14i will show the asset ID 538 as well as provide links 540 and 542 to respectively play the asset on IPTV if the viewer is so authorized, and put the asset on one or more various lists such as a list of favorites, IPTV list, queue for video-stream subscription service, and the like. In a similar manner, when the page viewer 400 clicks on the service link 510 on the social networking page 504, he or she can learn information 526 and/or other details about the service offering available to deliver the recommended asset from an IPTV domain page 524 that may be served by the web server 201 (FIG. 2). For example, the service might be IPTV video-on-demand and information 526 could include a listing of the available IPTV titles (e.g., movies, television shows, music, games, documentaries, specials, etc.) and associated descriptions, pricing when applicable, dates of availability, and the like. The information 526 may also include a link (not shown) that takes the viewer 400 to the service's external webpage when clicked. A second display link 528 is also supported on the social networking page which, when clicked by a viewer 400, may cause the management server 18 to issue commands to responsively open the viewer's own web app on the second display 14i.

If a viewer clicks on the platform link 512, information 546 about the IPTV platform may be made available to viewers on a page 544 served from the IPTV domain dealing with various features, functions, advantages, use cases, tips for getting the most out of the platform, and the like. In some instances, the information 546 may identify the specific manufacturer and model number of the user's IPTV. Advertising content about the platform (or other platforms) may also be included in the information 546 in some cases. The advertising may be of general interest to social networking service viewers, or be personalized in instances when a viewer is also an IPTV user that is serviced by the infrastructure associated with the management server 18 in the IPTV domain 200 (FIG. 2). In this latter case, the management server 18 would typically have knowledge of that viewer's IPTV platform so the advertising could be more specific, for example, and may include upgrade opportunities to the viewer's current IPTV platform, complementary hardware or accessory information, and the like. The information 546 can further include a link 548 that when clicked enables the page viewer 400 to go directly to the web app on the second display.

A share link 514 is supported on the social networking page 504. When the page viewer 400 clicks on the share link 514, the social networking site enables the viewer to share the feed with friends on the network. For example, a social networking page of a friend 530 may show the feed as indicated by reference numeral 532. Viewers of that page 530 may be provided with an additional share link 534 to propagate the feed sharing with additional members of the social networking community.

A second display link 516 is also supported on the social networking page which, when clicked by a viewer 400, may cause the management server 18 to issue commands to responsively open the viewer's own web app on the second display 14i and to focus on the asset link 508 to thus enable playback of the asset on the viewer's own IPTV, for example. Alternatively, the viewer 400 may be directed to another website associated with the management server infrastructure such as the web server 201 (FIG. 2) which can be more content related and not necessarily including functionality related to controlling an IPTV. In some implementations of the present arrangement, a separate discrete second display object is not utilized and its functionality may be incorporated into the asset link 508. In this case, clicking on the asset link 508 will enable access to the asset via the social networking page viewer's own second display so that playback of the asset may be implemented on the viewer's content playback device such as an IPTV.

Variations of the present system and method are now described.

If the content playback device were already playing content, the new content commanded to be played by the second display may be placed in a queue in the content playback device and played when the current content completes. In any case, once the content has been commanded to be played, the user may continue to browse the second display for other content, to play or to add to the queue. Other users may employ their own second displays to do the same. A user may also desire to switch devices and resume playback on a different device by, for example, navigating to a “recently viewed” list and selecting the last video played after switching control to the desired device.

The above description has been for the case where the proxy server 22 is employed to hide the content source, for example, a content URL/URI, from the second display 14i. That is, the proxy server 22 provides an API for the second display to use so that the content and/or content URL/URI cannot be accessed directly and the details of the management server transactions to access the services remain desiredly unknown. In many cases, the second display 14i may have stored thereon little or nothing of the content playback device 12 details. In some cases, however, the URL/URI may be directly provided from the proxy server 22 or the proxy server 22 may even be bypassed, for example, in cases where the content item is intended for free distribution, such as movie trailers or the like. Similarly, while the above description has focused on content item playback on content playback device 12, certain content items such as those which are intended for free distribution, may be played back on the second display 14i itself, if the same has been appropriately configured, for example by using the plug-in or helper application described above.

In the case where multiple second displays request content to be played at or near the same time, a simple rule such as the first-in-time may prevail. Alternatively, a priority scheme may be configured, such that certain second displays take precedence over other second displays.

Note further that the control device may command the content playback device to play content by sending to the content playback device over the local network commands coded as if they were sent from an infrared remote control, specifically for example the commands may be in the Sony Infrared Remote Control System (SIRCS) protocol.

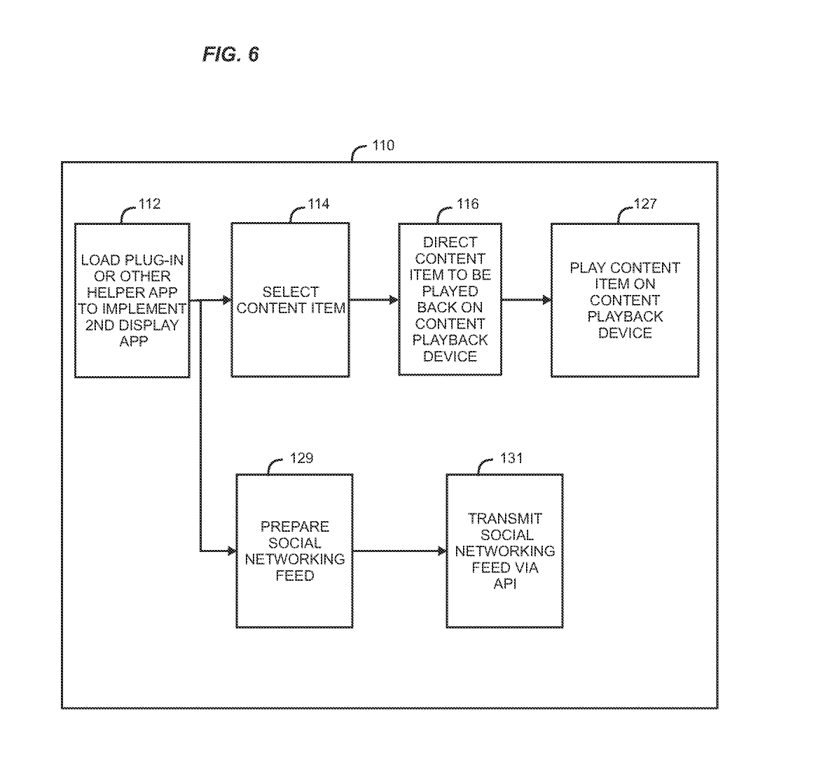

FIG. 6 illustrates one exemplary method 110 by which software may be employed to handle playback of media, especially video, in web browsers that, in addition to or instead of playing the media in the web browser, will use the second display protocol to instruct a separate display device, such as a content playback device, to play the media. In addition, as the playback response is being prepared, software may be employed to prepare the feed 218 to the social networking service 215 via the API 202 to the server 205 (FIG. 2).

One context of the system and method may be that a user opens a browser window and requests a content item to be played back, although variations will be seen by one of ordinary skill in the art given this teaching. A first step is loading a second display application (step 112). Steps may then occur such as a selection of a content playback device and selection of a service provider (not shown). A next step is that a content item is selected at the second display application (step 114). A next step is that the content item is directed to be played back on the content playback device (step 116). The content item may then be played back by the content playback device (step 127). As noted above, as content is readied for playback, the feed to the social networking service is prepared (step 129) and then transmitted to the social networking service 215 via the API 202 shown in FIG. 2 (step 131).

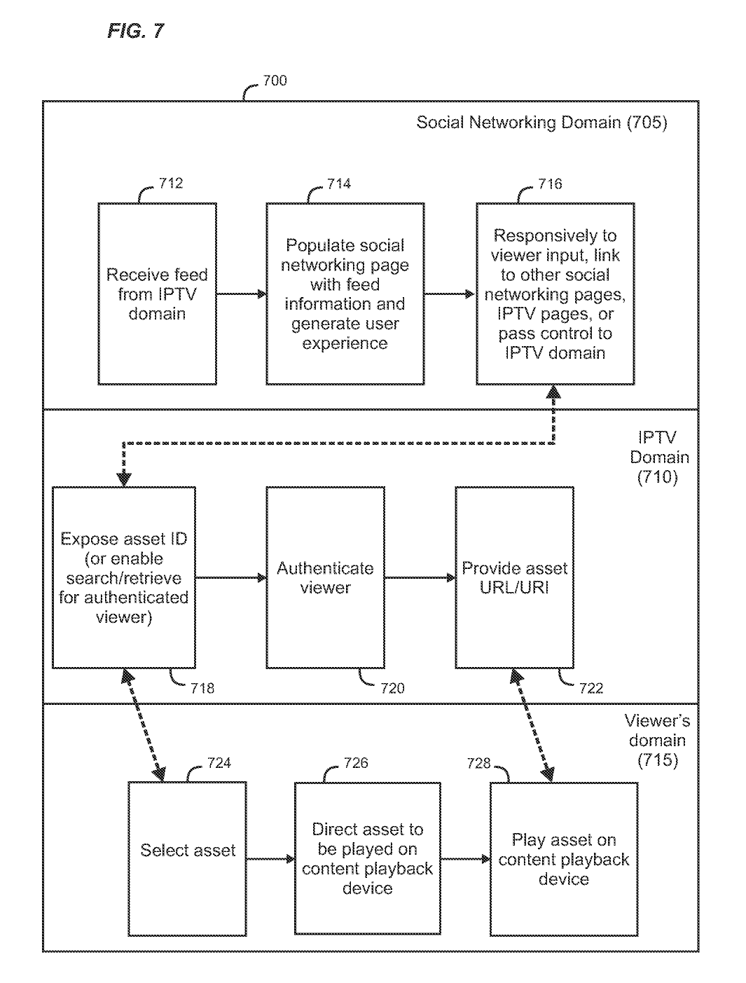

FIG. 7 is a flowchart illustrating an exemplary method 700 by which software instantiated and executed in various ones of a social networking domain 705, IPTV domain 710, and social networking page viewer's domain 715 is employed to enable the viewer 400 (FIG. 4) to interact with objects populated into a social networking page using the feed provided to the social networking server 310 (FIG. 3). In the social networking domain 705, a first step is receiving the feed from the IPTV domain (step 712). A next step is for a receiving site in the social networking domain 705 to populate one or more pages with information from the received feed (step 714). The viewer 400 can then interact with links, objects, and various controls on the populated pages as part of an overall social networking experience. In response to such interaction, the social networking site links or transfers program control to other social networking pages, or to pages in the IPTV domain such as those served by web server 201 (FIG. 2) (step 716).

In one example where control is passed to the IPTV domain, the social networking page viewer 400 has clicked on the asset link on the page in order to attempt to play, or otherwise interact with a recommended IPTV asset. In this case, the servers utilized in the IPTV domain will expose the asset to a second display (step 718) in the viewer's domain 715 so that the asset can be selected (step 724) by the viewer 400 and directed for playback (step 726) on the content playback device such as an IPTV (step 728). When executing the viewer's selection in the IPTV domain 710, the viewer will be authenticated (step 720), for example, by virtue of the second display's use of the content playback device's authentication credential. If the recommended IPTV asset is not able to be played back because, for example, the viewer's second display is not set to control an appropriate content playback device, the viewer may change his or her control to an appropriate one and then access the recommended asset. It is noted that in some cases, because of content restrictions, the viewer will be able to see the asset link and associated information but otherwise be unable to interact with the asset in a more comprehensive manner. If the viewer is authenticated, then the content server will provide the URL/URI of the recommended asset to the viewer's content playback device (step 722).

Aspects of various components are described below.

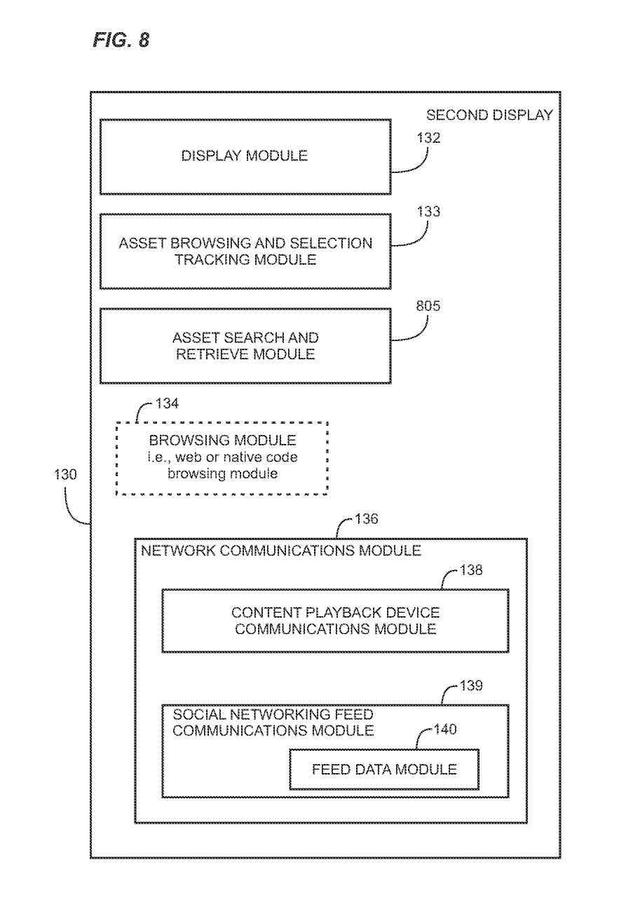

FIG. 8 illustrates one implementation of a second display 130. The second display 130 includes a display module 132 for use in, among other aspects, browsing lists and selecting items related to the content playback device. For example, a list of content playback devices accessible to the local network and/or addressable by the second display may be displayed using the display module 132, and the user may choose a content playback device from among them. In addition to choosing a content playback device, or instead of, a user may review a list of accessible service providers using the display module 132. For example, such service providers may include those offering video on demand services for movies and other video content, or any number of other sites on which media and content may be browsed and selected. In one implementation, where a content playback device has been chosen, the results may be filtered based on the capability of the device to render the content. In another implementation, the display module 132 may display not just content accessible to the local network, but also content resident on the local network, such as content stored on a digital video recorder or Blu-ray® player.

The second display 130 includes an asset browsing and selection tracking module 133 that implements tracking of the user's browsing and selection of assets including, for example, content items, playback platform, services, providers, etc. The user's behavior regarding these assets is tracked so that the data can be collected for the feed to the social networking service. The second display 130 further includes an asset search and retrieve module 805 that implements an asset search and retrieve capability using the content playback device's authentication credential.

Also within the second display 130 there may be a browsing module 134 through which the above noted content items may be browsed in the case where the second display application is written in HTML and Javascript. The web-browsing module 134 may be implemented in a number of ways, including by executing application code written in HTML, Javascript, or the like. A web browsing module implemented in such a way allows the same to be implemented across many platforms, allowing any number of types of second displays to be employed. As noted above, second display applications written in native code may also be employed. Moreover, in some cases, special applications, e.g., helper applications, may be employed to communicate with particular proprietary or non-web-based technologies. The web-browsing module 134 may also include various plug-in modules to enable different content types to be played back in the browser itself. Such plug-ins may in some cases allow content items to be viewed in the second display, such as before their redirection to the content playback device. Where the second display application is non-web-based, and is written in, for example, native code, the web-browsing module 134 may be replaced with a suitable other module allowing service and content selection or other such functionality.

The second display 130 also includes a module for network communications 136. The network communications module 136 allows the second display to communicate with the local network as well as, in some cases, specific devices directly. As part of the network communications module 136, a communications module 138 for communications with a content playback device is provided. The content playback device communications module 138 allows the second display to communicate with the content playback device either over the local network or directly (Internet communications may also be employed). Such direct communications may include various types of wired or wireless transmission schemes, including WiFi, USB, infrared, Bluetooth®, or the like.

The network communications module 136 further includes a social networking feed communications module 139. The social networking feed communications module 139 allows the second display to communicate with the management server and/or proxy server so that data resulting from the tracking of the user's asset browsing and selection behavior can be collected and sent as the feed to the social networking server. The social networking feed module 139 can be configured to store and/or buffer the data provided in the feed which is implemented, in this example, using a feed data module 140.

It is noted that the above modules may be implemented in hardware, non-transitory software, or a combination of the above. Typically, the same will be implemented within the context of a laptop computer, a tablet computer, a smartphone, or the like.

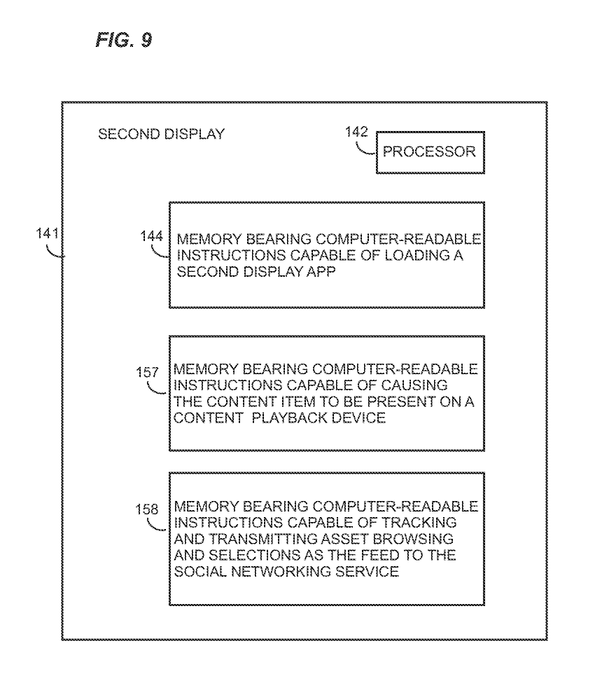

Referring to FIG. 9, another implementation of a second display 141 is illustrated. In this implementation, the second display 141 includes a processor 142. The second display 141 further includes memory 144 bearing computer-readable instructions capable of loading a second display application.

The second display 141 may also include memory 157 bearing computer readable instructions capable of causing a content item to be present on a content playback device. With memory 157, the content item may be made present by downloading from a service provider, either directly or through a management or proxy server. In this regard, the request for the content item may be configured to be made from the content playback device or from the second display.

Alternatively, or in combination, the second display 141 may include memory 158 bearing computer readable instructions capable of tracking user behavior with regard to asset browsing and selection and facilitating the transmission of the feed to the social networking service, either directly or through the management or proxy server.

Systems and methods have been disclosed that allow improvement of the user experience of the IPTV without adding to the hardware costs of the unit. As disclosed above, software may be created and employed to handle the playback of media, especially video, in a content playback device by a second display. Data pertaining to the user's behavior in browsing, selecting, and playing media, from particular sources on a particular platform, is tracked (with the user's permission) so that a feed representative of such behavior may be transmitted to one or more social networking services for publication.

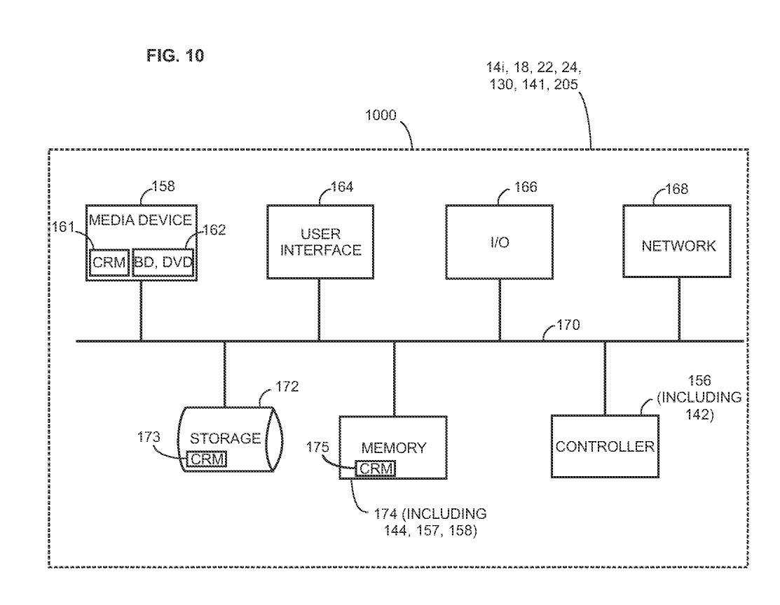

One implementation includes one or more programmable processors and corresponding computing system components to store and execute computer instructions, such as to execute the code that provides the second display or various server functionality, as well as for browsing. Referring to FIG. 10, a representation of such an exemplary computing device 1000 for a second display 14i, proxy server 22, management server 18, content server 24, web server 201, or social network server 310, is illustrated.

The computing device includes a controller 156, a memory 174, storage 172, a media device 158, a user interface 164, an input/output (I/O) interface 166, and a network interface 168. The components are interconnected by a common bus 170. Alternatively, different connection configurations can be used, such as a star pattern with the controller at the center.

The controller 156 includes a programmable processor and controls the operation of the computing device and its components. The controller 156 loads instructions from the memory 174 or an embedded controller memory (not shown) and executes these instructions to control the system. In its execution, the controller 156 may provide, for example, the second display 14i control of a content playback device system 12 as, in part, a software system. Alternatively, this service can be implemented as separate modular components in the controller 156 or the second display 14i.

Memory 174, which may include non-transitory computer-readable memory 175, stores data temporarily for use by the other components of the computing device 1000 and the same may include memories 144, 157, and 158 as discussed above. In one implementation, memory 174 is implemented as RAM. In other implementations, memory 174 also includes long-term or permanent memory, such as flash memory and/or ROM.

Storage 172, which may include non-transitory computer-readable memory 173, stores data temporarily or long-term for use by other components of the computing device 1000 such as for storing data used by the system. In one implementation, storage 172 is a hard disc drive or a solid state drive.

The media device 158, which may include non-transitory computer-readable memory 161, receives removable media and reads and/or writes data to the inserted media. In one implementation, the media device 158 is an optical disc drive or disc burner, for example, a writable Blu-ray® disc drive 162.

The user interface 164 includes components for accepting user input, for example, the user content selections, from the user of the computing device 1000 and presenting information to the user. In one implementation, the user interface 164 includes a keyboard, a mouse, audio speakers, and a display. The controller 156 uses input from the user to adjust the operation of the computing device 1000.

The I/O interface 166 includes one or more I/O ports to connect to corresponding I/O devices, such as external storage or supplemental devices such as a printer or a PDA. In one implementation, the ports of the I/O interface 166 include ports such as USB ports, PCMCIA ports, serial ports, and/or parallel ports. In another implementation the I/O interface 166 includes a wireless interface for wireless communication with external devices. These I/O interfaces may be employed to connect to one or more content playback devices.

The network interface 168 allows connections with the local network and optionally with content playback device 12 and includes a wired and/or wireless network connection, such as an RJ-45 or Ethernet connection or “WiFi” interface (802.11). Numerous other types of network connections will be understood to be possible, including WiMax, 3G or 4G, 802.15 protocols, 802.16 protocols, satellite, Bluetooth®, or the like.

The computing device 1000 may include additional hardware and software typical of such devices such as power and operating systems, though these components are not specifically shown in the figure for simplicity. In other implementations, different configurations of the devices can be used, such as different bus or storage configurations or a multi-processor configuration.

Various illustrative implementations of the present invention have been described. However, one of ordinary skill in the art will recognize that additional implementations are also possible and within the scope of the present invention.

For example, while the application running on the second display has been disclosed in generic terms as a second display application, the same may be a web app, a native application, a Java application, or any other sort of application that may control at least in part a content playback device. Moreover, while several implementations of the invention include that the user select a particular content playback device for playback, in some implementations a user may browse content with no content playback device selected at all. In other implementations, a cache or cookie or other information may be employed to store information about content playback devices, so that no user choice is necessary. In another example, samples of content items may be obtained from content service providers, and these samples may be browsed freely without a user selection of a content playback device for playback. In another variation, a profile system may be employed that communicates content playback device information upon start-up according to a profile. For example, a given content playback device may always be associated with and may authenticate itself with a given service provider. In this sense, a content playback device is still being chosen, but the choice does not require an affirmative step by the user. Use of any of these alternatives, or others, ensures that the content consumption of each content playback device is tracked. It further allows, as described, the proxy server to filter out content that the content playback device is incapable of playing. It is also noted that certain types of browsing may require no device at all such as browsing shopping sites. Still, some level of customization may occur, for example, by consideration of the origination location of the visiting second display's IP address.

Content items from any suitable source are contemplated, including but not limited to: networked, wireless, including 3G, 4G, and the like, local, such as from a local or shared drive or accessible via DLNA or accessible via a specialized network storage device, or accessible via removable media such as a media card or USB storage device, CD, DVD, or Blu-ray®. Content may also be accessed from a cell phone, portable media player, camera or camcorder, or other devices the second display may access. In addition, any suitable types of content items are contemplated, including but not limited to AC3, MP3, MPEG, etc. Any suitable format of content items is contemplated, including but not limited to m3u, ASX, ASX-XML, etc. Any suitable protection scheme is contemplated, including but not limited to DRM, etc. Any suitable protocol is contemplated, including but not limited to HTTP, HTTPS, etc. Any suitable playback method is contemplated, including but not limited to those varying in buffering limit, when to buffer, treating video playback differently from audio playback, and the like.

In addition, the above description was primarily directed to an implementation in which the local IP address of the second display was retrieved and stored on the server. However, other ways of discovering the second display are also possible. For example, device discovery is also possible using a broadcast method within the local network. Compatible devices that recognize the broadcast message will respond with their necessary credentials and information to indicate their compliance with the web application for the second display. In many cases, broadcasting methods are primarily directed to native applications, not web applications; however, a broadcasting library may be employed to allow the implementation within a web application. Such methods also apply to the discovery of content playback devices on the network.

While the above description has focused on implementations where a second display is coupled to a content playback device through a local network, it will be understood that the same will apply to any method by which the two may communicate, including 3G, 4G, and other such schemes.

Accordingly, the present invention is not limited to only those implementations described above.

1. A method for facilitating interaction between a second display and a social networking feed, comprising:
i. receiving a social networking feed that includes tracked data representative of browsing, selection, or playback of an asset by an IPTV user;
ii. generating one or more social networking pages for consumption by a viewer of the pages, the generating using the received feed, the social networking pages including at least one of an IPTV user link, asset link, service link, platform link, share link, or second display link; and
iii. implementing control for the interaction at the second display responsively to selection of a link by the viewer from the one or more social networking pages.

2. The method of claim 1, wherein the implementing includes instantiating an application on the second display, the application being one of a web app, native application, Java application, or application written using ASPI.NET framework.

3. The method of claim 1, wherein the implementing includes causing the asset to play back in a content playback device associated with the viewer.

4. The method of claim 3, wherein the causing includes causing the content playback device to request the asset from a content server.

5. The method of claim 3, wherein the second display is authenticated using an authentication credential associated with the content playback device.

6. The method of claim 1, wherein the generating is performed by a social networking service provider.

7. The method of claim 1, wherein the feed includes tags compliant with an API exposed by a server operated on behalf of the social networking service provider.

8. The method of claim 1, wherein upon selection of the IPTV user link by the viewer, a social networking page providing information about the IPTV user is presented for viewing by the viewer, the social networking page further including a link for the viewer to invoke the second display or an option for the viewer to add the IPTV user as a social networking friend.

9. The method of claim 1, wherein upon selection of the asset link by the viewer, viewer-selectable options are presented on the second display, the options including at least one of causing the asset to playback on a content playback device, or putting the asset on a list, the list comprising a favorites list or a queue for a video-stream subscription service.

10. The method of claim 1, wherein upon selection of the service link by the viewer, an IPTV domain page providing information about an IPTV service is presented for viewing by the viewer, the IPTV domain page further including a link for the viewer to invoke the second display.

11. The method of claim 1, wherein upon selection of the platform link by the viewer, an IPTV domain page providing information about an IPTV platform is presented for viewing by the viewer, the IPTV domain page further including a link for the viewer to invoke the second display.

12. The method of claim 1, wherein upon selection of the share link by the viewer, the feed is shared with a social networking user specified by the viewer.

13. The method of claim 1, wherein a connection between the content playback platform and second display is wireless, and wherein a wireless transmission scheme includes a scheme selected from the group consisting of: WiFi, 802.11, 802.15, or 802.16.

14. The method of claim 1, wherein the received feed is personalized on a per-viewer basis and is adapted for publication in substantially real time or wherein the feed is configured to be representative of a plurality of viewers and is further adapted for publication in bulk in substantially non-real time.

15. A non-transitory computer-readable medium, comprising instructions for causing a computing device to implement the method of claim 1.

16. A second display, comprising:
i. a display module, the display module providing a user interface and configured to display a content item or to receive a content item URL/URI;
ii. an asset search and retrieval module adapted for searching and retrieving an asset recommended from an IPTV viewer and published in a feed to a social networking service; and
iii. a network communications module, the network communications module for coupling the second display to a local network or to a content playback device and for causing the recommended asset to playback on the content playback device.

17. The second display of claim 16, further comprising a browsing module for browsing content items.

18. The second display of claim 17, wherein the browsing module is implemented in HTML, Javascript, or a native code using at least one of local execution, cloud-computing paradigm, or combination thereof.

19. The second display of claim 17, wherein the browsing module is a web-browsing module.

20. The second display of claim 16, wherein the coupling is via a wireless communication scheme.

21. A method for using a feed from an IPTV domain at a social networking service, comprising:
i. receiving a feed populated with one or more data objects at an API exposed by the social networking service, the data object representing at least one of an asset, IPTV service, IPTV platform, or IPTV user, the asset being provided from the IPTV service to which the IPTV domain is coupled over a network;
ii. generating one or more social networking pages incorporating the data objects from the feed as native social networking content;
iii. enabling a viewer of the pages to manipulate the data objects; and
iv. invoking an action in response to the manipulation.

22. The method of claim 21, wherein the invoked action comprises provision of additional information from the feed.

23. The method of claim 22, wherein the additional information is one of information about the IPTV service, IPTV platform, or IPTV user.

24. The method of claim 21, wherein the invoked action comprises passing control from the social networking pages to a page in the IPTV domain or to a second display associated with the viewer.

25. The method of claim 24, wherein the control passed to the second display enables the viewer to cause the asset to play back on a content playback device.

26. The method of claim 21, in which the asset is a recommended asset generated by tracking browsing, selection, and playback behaviors of the IPTV user.
